(19) United States
(12) Patent Application Publication
(10) Pub. No.: US 2025/0298856 A1
(43) Pub. Date: Sep. 25, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Kento ISHIDA, Tokyo (JP); Akishi TSUMORI, Tokyo (JP); Masayori NUMAZAKI, Tokyo (JP)

(21) Appl. No.: 19/053,208

(22) Filed: Feb. 13, 2025

(30) Foreign Application Priority Data
Mar. 19, 2024 (JP) 2024-044270

(51) Int. Cl. G06F 16/9538; G06F 16/9532

(52) U.S. Cl. CPC G06F 16/9538; G06F 16/9532

(57) ABSTRACT

An information processing apparatus according to the present application includes a generation unit that generates a question based on a search query used for searching for web content, a reception unit that receives an answer by a user to the question generated by the generation unit, and a provision unit that provides information including the question generated by the generation unit and the answer received by the reception unit.

### CROSS-REFERENCE TO RELATED APPLICATIONS

The present application claims priority to and incorporates by reference the entire contents of Japanese Patent Application No. 2024-044270 filed in Japan on Mar. 19, 2024.

### BACKGROUND OF THE INVENTION

### 1. Field of the Invention

The present invention relates to an information processing apparatus, an information processing method, and a non-transitory computer readable storage medium.

### 2. Description of the Related Art

In recent years, a service of sharing information among users via a network such as the Internet has become active. In this type of service, for example, with respect to a question posted by a certain user (questioner), by another user (answerer) posting an answer, knowledge and wisdom are shared among the users (see, for example, Japanese Laid-open Patent Publication 2019-125146).

However, in the related art, for example, it may be difficult to obtain information desired by a user in a field where there are few questions, and there is room for improvement from the viewpoint of improving convenience of the user.

### SUMMARY OF THE INVENTION

An information processing apparatus according to the present application includes a generation unit that generates a question based on a search query used for searching for web content, a reception unit that receives an answer by a user to the question generated by the generation unit, and a provision unit that provides information including the question generated by the generation unit and the answer received by the reception unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view illustrating an example of information processing according to an embodiment;

FIG. 2 is a view illustrating an example of a configuration of an information processing system according to the embodiment;

FIG. 3 is a view illustrating an example of a configuration of an information processing apparatus according to the embodiment;

FIG. 4 is a view illustrating an example of a user information table stored in a user information storage unit of the information processing apparatus according to the embodiment;

FIG. 5 is a view illustrating an example of a question history table stored in a question history information storage unit of the information processing apparatus according to the embodiment;

FIG. 6 is a view illustrating an example of an answer history table stored in an answer history information storage unit of the information processing apparatus according to the embodiment;

FIG. 7 is a view illustrating an example of question generation information provided by a provision processing unit of a provision unit in the processing unit of the information processing apparatus according to the embodiment, transmitted to a terminal, and displayed on a terminal apparatus;

FIG. 8 is a view illustrating an example of answer input information provided by the provision processing unit of the provision unit in the processing unit of the information processing apparatus according to the embodiment, transmitted to the terminal, and displayed on the terminal apparatus;

FIG. 9 is a flowchart indicating an example of information processing by the processing unit of the information processing apparatus according to the embodiment; and

FIG. 10 is a hardware configuration diagram illustrating an example of a computer that implements functions of the information processing apparatus according to the embodiment.

### DETAILED DESCRIPTION OF THE PREFERRED EMBODIMENTS

Hereinafter, a mode (hereinafter, referred to as an “embodiment”) for implementing an information processing apparatus, an information processing method, and an information processing program according to the present application will be described in detail with reference to the drawings. Note that the information processing apparatus, the information processing method, and the information processing program according to the present application are not limited by the embodiment. In addition, each embodiment can be appropriately combined within a range in which the processing content does not contradict each other. Further, in the following embodiment, the same parts are denoted by the same reference numerals, and redundant description will be omitted.

### [1. Example of Information Processing]

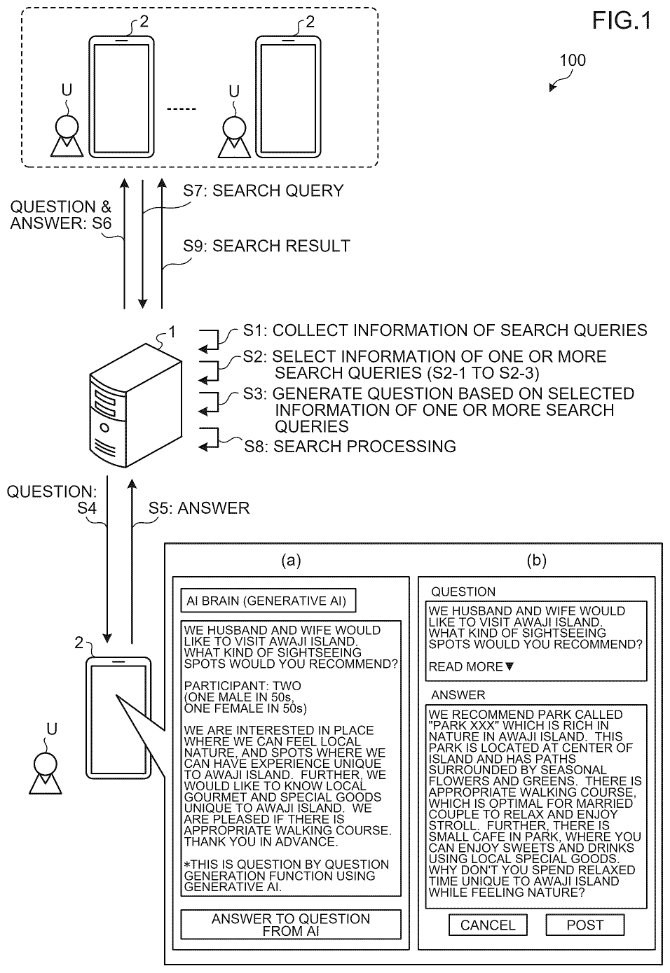

First, an example of information processing according to an embodiment will be described with reference to FIG. 1. FIG. 1 is a view illustrating an example of the information processing according to the embodiment. Note that FIG. 1 illustrates an operation example of an information processing system 100 according to the embodiment including an information processing apparatus 1.

As illustrated in FIG. 1, the information processing system 100 according to the embodiment includes the information processing apparatus 1 and a plurality of terminal apparatuses 2. Each terminal apparatus 2 is a terminal apparatus of a user U to whom various kinds of content are to be provided from the information processing apparatus 1. The various kinds of content transmitted from the information processing apparatus 1 include search results of web content in a web search service and content of a Q&A (question & answer) service. Hereinafter, the web search service and the Q&A service will be mainly described as services to be provided by the information processing apparatus 1.

For example, an application program (hereinafter, an application may be referred to as a Q&A application) for using the Q&A service is installed in the terminal apparatus 2, so that the user U of the terminal apparatus 2 can use the Q&A service by starting the Q&A application.

The Q&A application can transmit and receive information regarding the Q&A service to and from the information processing apparatus 1 via an interface such as an application programming interface (API). For example, the Q&A application can transmit information input to the terminal apparatus 2 to the information processing apparatus 1 and can receive information from the information processing apparatus 1.

As illustrated in FIG. 1, the information processing apparatus 1 collects information of search queries used for searching for web content in the web search service (Step S1). For example, the information processing apparatus 1 collects information of the search queries from an internal storage unit, a search server, or the like.

The information of the search queries includes the search queries, information of the user U who has transmitted the search queries, information indicating date and time of the search queries, and the like. The search queries include words, phrases, and the like, input by the user U. The information of the user U includes information indicating an attribute of the user U.

Subsequently, the information processing apparatus 1 selects information of one or more search queries from the information of the plurality of search queries collected in Step S1 (Step S2). For example, the information processing apparatus 1 classifies the information of the plurality of search queries for each category (Step S2-1). The categories in the Q&A service are classified by a combination of a large classification, a middle classification, and a small classification.

The large classification is a classification such as an item “region, travel, outing”, an item “entertainment and hobby”, an item “health, beauty and fashion”, an item “child raising and school”, an item “business, economy and money”, an item “occupation and carrier”, and an item “computer technology”, but is not limited to such an example.

In a case where the large classification is the item “region, travel, outing”, the middle classification is a classification such as an item “domestic”, an item “overseas”, and an item “traffic, map”. Furthermore, in a case where the large classification is the item “entertainment and hobby”, the middle classification is a classification such as an item “entertainer”, an item “TV, radio”, an item “music”, an item “movie”, an item “drama, musical”, an item “anime, comic”, an item “game”, and an item “book, magazine”, but is not limited to such an example.

In a case where the large classification is the item “region, travel, outing” and the middle classification is the item “domestic”, the small item is an item such as an item “sightseeing spot”, an item “zoo, aquarium”, an item “hotel, inn”, an item “hot spring”, an item “event, festival”, and an item “local gourmet”, but is not limited to such an example. In a case where the large classification is the item “entertainment and hobby” and the middle classification is the item “movie”, the small item is an item such as an item “Japanese movie” and an item “foreign movie”.

In Step S2-1, the information processing apparatus 1 classifies the plurality of search queries for each category by, for example, classification based on a rule or classification using a machine learning model. For example, the information processing apparatus 1 has a keyword list in which a plurality of keywords is associated with each category, and can classify the search query into a category having the largest number of keywords included in the keyword list among words included in the search query.

In addition, the information processing apparatus 1 can classify the plurality of search queries into categories using a classification model learned using a plurality of pieces of teacher data (pairs of search queries and categories). The classification model is generated, for example, by converting each search query of the teacher data into a feature amount and performing learning using the feature amount.

The feature amount is, for example, term frequency-inverse document frequency (TF-IDF), bag of words (Bow), or the like, but is not limited to such an example. The classification model is, for example, a regression model, support vector machine, a gradient boosting decision tree, a convolutional neural network, or the like, but is not limited to such an example.

The information processing apparatus 1 extracts information of one or more search queries for each category based on information of the plurality of search queries classified for each category (Step S2-2). For example, the information processing apparatus 1 extracts one or more search queries satisfying a predetermined first condition for each category.

The first condition is, for example, a condition that the search query includes one or more trend words up to the top m-th rank (m is an integer of 1 or more), or a condition that the search query of the user U for whom a frequency of posting questions in the Q&A service is equal to or higher than a threshold, but is not limited to such an example.

The trend word is a word for which a proportion included in the search query is increasing. For example, the trend word is a word for which a rate of increase in the number of appearances per unit time is equal to or greater than a threshold and the latest number of appearances is equal to or greater than a threshold among words included in a plurality of search queries in a period up to a time before a predetermined period.

The information processing apparatus 1 selects information of a search query satisfying a predetermined second condition from among the one or more search queries for each category extracted in Step S2-3 (Step S2-3). The second condition is a condition that a combination of a plurality of terms that is not included in a question posted in a period up to a time before a predetermined period is included, or a condition that a combination of a plurality of terms that is included in a question posted in a period up to a time before a predetermined period but has a low posting frequency is included, but is not limited to such an example.

At least one of the first condition and the second condition may be a condition different for each category. For example, in a case where the large classification of the search query is the item “region, travel, outgoing”, the second condition may be a condition that information indicating a place is included, a condition that information indicating a place and information indicating a purpose at the place are included, or a condition that a combination of the plurality of terms described above is a combination of information indicating a place and information indicating a purpose at the place.

Note that the information processing apparatus 1 can also collectively perform the processing of Step S2-2 and the processing of Step S2-3. Furthermore, in Step S2-3, the information processing apparatus 1 can also select information of search queries randomly selected from among the one or more search queries for each category extracted in Step S2-2.

Furthermore, the information processing apparatus 1 can also select the information of one or more search queries for each category randomly based on the information of the plurality of search queries classified for each category in the processing of Step S2-3 without performing the processing of Step S2-2.

Subsequently, the information processing apparatus 1 generates a question based on the information of the one or more search queries for each category selected in Step S2 (Step S3). For example, the information processing apparatus 1 generates a question including a plurality of terms included in the search query for each category.

The question generated by the information processing apparatus 1 is generated by, for example, a generation method selected by an operator of the information processing apparatus 1 among a rule-based generation method and a generation method using artificial intelligence (AI).

The rule-based generation of the question is performed, for example, by extracting a plurality of types of terms according to the category from the search query using a category term list including a list of a plurality of types of terms for each category, and applying the extracted plurality of types of terms to a sentence of a template for each category.

For example, in a case where the category of the search query is the item of the large classification “region, travel, outgoing”, the category term list includes a list of terms indicating places and a list of terms indicating purposes. The information processing apparatus 1 extracts a term indicating a place and a term indicating a purpose at the place from the search query using the category term list. The search query for extracting the term indicating the place and the search query indicating the term indicating the purpose may be the same or different from each other.

Then, the information processing apparatus 1 generates a question by applying the term indicating the place extracted from the search query and the term indicating the purpose at the place to specific portions in the sentence of the template of the category including the item of the large specification “region, travel, outgoing”.

For example, the template is information of a character string “We would like to {term indicating the purpose} at {term indicating the region}. If you have any recommendation, please let us know”, or the like, but is not limited to such an example. The term indicating the place extracted from the search query is applied to the {term indicating the region}, and the term indicating the purpose extracted from the search query is applied to the {term indicating the purpose}.

{Term indicating the region} is, for example, a term indicating a name of a region such as Kyoto, Awaji island, and Kanazawa, and {term indicating the purpose} is, for example, a term indicating a purpose such as travel, sightseeing, eating and drinking, and staying, but is not limited to such an example.

Note that the template may be different according to the combination of the large classification and the middle classification, or may be different according to the combination of the large classification, the middle classification, and the small classification.

In addition, the information of the search query includes the search query and the information of the user U of the terminal apparatus 2 that has transmitted the search query. The information processing apparatus 1 can generate a question using the information of the user U in addition to the search query.

The information of the user U includes, for example, information indicating the attribute of the user U. The attribute of the user U is a demographic attribute such as gender, generation (age), address, family structure, occupation, and annual income, but may be a psychographic attribute such as an interest of the user U, a lifestyle, and an idea or tendency of an idea, or may be a combination of the demographic attribute and the psychographic attribute.

For example, the information processing apparatus 1 can generate a question using a template including information of a character string “We would like to {term indicating the purpose} at {term indicating the region}. If you have any recommendation, please let us know. \n \n Participant: {family structure}”. The family structure based on the information indicating the attribute of the search query is applied to {family structure}. For example, the family structure is information of a character string “1 male in 40s, 1 female in 40s, 1 male junior high school student”. In this manner, the information processing apparatus 1 can generate the question based on the search query and the information indicating the attribute of the user U of the terminal apparatus 2 that has transmitted the search query.

The generation of the question using the generative AI is generation using the generative AI capable of generating a text, and inputs information including information of the search query selected in Step S2 to the generative AI as input information, and causes the generative AI to output the question.

The generative AI is, for example, text generative AI. The text generative AI is, for example, a large-scale language model learned to estimate and output a next token from an input token string, and is, for example, a transformer-based model, a recurrent neural network (RNN)-based model, or the like, but may be a mixed model thereof, or the like. Furthermore, the text generative AI may be a composite system combined with identification machine, or the like, for preventing unauthorized use.

The transformer-based model is, for example, generative pre-trained transformer (GPT) (registered trademark), pathways language model version 2 (PaLM2), large language model meta AI (LLAMA), or the like, but is not limited to such an example. The RNN-based model is, for example, a reception weighted key value (RWKV), or the like, but is not limited to such an example.

Note that the generative AI is desirably learned so as not to include personal information, or the like, in the generation result. The generative AI is arranged in an external information processing apparatus, and the information processing apparatus 1 uses the generative AI via an API, but the generative AI may be arranged in the information processing apparatus 1.

The information processing apparatus 1 inputs information including information of the search query and instruction information indicating an instruction to generate a question using the information of the search query to the generative AI, and can cause the generative AI to generate a question according to the information of the search query.

The instruction information is, for example, information of a character string “You have a high-level question skill. Please create a question that many people find useful based on the given keyword”, but is not limited to such an example.

Further, the instruction information may include a restriction condition. The restriction condition is, for example, an upper limit value of the number of characters, an expression format, limitation of the type of each item included in the output content, and the like, and is set for each category, for example. The expression format is, for example, an expression format in a desu/masu form, an expression format in a veneer form, or the like. The items included in the output content are, for example, “participant”, “period”, and the like, in a case of a question regarding sightseeing, and are “participant”, “use application”, “drinking schedule”, “budget”, and the like, in a case of a question regarding gourmet, but are not limited to such an example. The “participant” includes, for example, age, gender, and the number of people.

The generative AI may be multi-modal generative AI, or the like. The multi-modal generative AI is, for example, generative AI capable of generating a text or an image from a text, an image, or the like. The multi-modal generative AI is, for example, GPT-4 Turbo with vision, gemini, chameleon multimodal model (CM3Leon), or the like, but is not limited to such an example.

Furthermore, in a case where the category is related to sightseeing or gourmet, the information processing apparatus 1 can include, in the instruction information, information indicating an instruction to include information indicating the attributes of all family members including the user U who has transmitted the search query as “participant” in the question, as information indicating the restriction condition. Furthermore, in the instruction information, information indicating an instruction to include “participant” in the question as a virtual persona to increase reality may be included in the information indicating the restriction condition. In this manner, the information processing apparatus 1 can generate the question based on the search query and the attribute of the user U of the terminal apparatus 2 that has transmitted the search query.

In a case where the information of the search query does not include the information indicating the attributes of the family members including the user U of the terminal apparatus 2 that has transmitted the search query, the information processing apparatus 1 can also estimate the attributes of the family members including the user U of the terminal apparatus 2 that has transmitted the search query.

For example, the information processing apparatus 1 has a keyword list that is a list of keywords for each attribute (gender, generation (age), family structure, etc.), and estimates the attribute of the keyword list having the highest proportion of words included in a plurality of search queries of the user U as the attribute of the user U.

The information processing apparatus 1 can also estimate the attribute of the user U using an attribute estimation model. The attribute estimation model is generated by machine learning using a data set of a plurality of words included in a plurality of search queries transmitted from the terminal apparatus 2 by the same user U and the attribute of the user U. The attribute estimation model is, for example, a regression model, a gradient boosting decision tree (GBDT), a neural network, or the like, but is not limited to such an example.

The attribute estimation model is, for example, a model in which the number of appearances of words included in the search query is set as a feature amount, and the information processing apparatus 1 inputs the number of appearances of a plurality of words included in a plurality of search queries transmitted from the terminal apparatus 2 of the user U to be estimated to the attribute estimation model, and estimates the attribute having the highest score for each attribute output from the attribute estimation model as the attribute of the user U.

Note that the information processing apparatus 1 can also estimate the attribute of the user U using the generative AI, for example. For example, the information processing apparatus 1 causes the generative AI to estimate the attribute of the user U by inputting, to the generative AI, a plurality of search queries transmitted from the terminal apparatus 2 of the user U to be estimated and instruction information including information indicating an instruction to estimate the attribute of the user U from the plurality of search queries.

Furthermore, in a case where the information indicating the purpose is not included in the search query, the information processing apparatus 1 can also instruct the generative AI to estimate the purpose at the place for which information is included in the search query. Furthermore, the information processing apparatus 1 has, for example, a purpose list in which purposes for each place are listed, and can estimate a purpose at the place for which information is included in the search query from the purpose list.

Furthermore, the instruction information may include information indicating information of the search query and an example of a question corresponding to the information of the search query. For example, the instruction information is information of a character string “#example \n\n #Search query example \n Yokosuka sightseeing \n #Question example \n Please let us know sightseeing spots in Yokosuka that can be enjoyed by family. \n\n Participant: family of three (1 male in 30's, 1 female in 30's, 1 female in 10's) \n Season: summer vacation (July to August) \n\n In particular, we are interested in experience-based attractions that children can enjoy and educational sightseeing spots. We also want to know delicious local gourmet spots. Thanks in advance”.

Furthermore, the instruction information may include, for example, another question that satisfies a predetermined condition as an example question. Examples of the other questions that satisfy the predetermined condition include, but are not limited to, other questions for which the number of answers is equal to or larger than a threshold, other questions for which a period from when a question is made until the predetermined number of answers are made is within a threshold, other questions for which the number of answers is in top m, and other questions for which a period from when a question is made until the predetermined number of answers are made is short in top n.

In addition, the information processing apparatus 1 generates a question to which an answer of a candidate for an answerer can be received, based on behavior history of the user U who is the candidate for the answerer. The candidate for the answerer is, for example, the user U for whom a frequency of answering the question is equal to or higher than a threshold, and is selected for each category, but is not limited to such an example. For example, the candidate for the answerer may be the user U for whom a rate selected as the best answer is equal to or higher than a threshold, or may be the user U for whom a frequency of answering a question is equal to or higher than a threshold and for whom a rate selected as the best answer is equal to or higher than a threshold.

The behavior history of the user U as the candidate for the answerer is, for example, history of behavior including a keyword included in the search query, and is, for example, history of behavior including a place indicated by the keyword included in the search query and a purpose at the place. The behavior history of the user U can also read as history of experience of the user U.

The information processing apparatus 1 generates a question to which the candidate for the answerer can easily answer based on the behavior history of the user U who is the candidate for the answerer. The behavior history of the user U includes history of answers made by the candidate for the answerer in the past, and the information processing apparatus 1 generates a question to which the candidate for the answerer can easily answer based on, for example, a question corresponding to an answer made by the candidate for the answerer in the past.

For example, the information processing apparatus 1 sets information further including information of a character string “The answerer who answers the question should create a question in consideration of ease of answer to the given question example” as instruction information, and inputs information including the instruction information and the question corresponding to the answer made by the candidate for the answerer in the past to the generative AI as input information.

Subsequently, the information processing apparatus 1 provides information including the question generated in Step S3 (Step S4). For example, the information processing apparatus 1 provides the candidate for the answerer with information including the question generated in Step S3 by transmitting information including the question generated in Step S3 to the terminal apparatus 2 of the candidate for the answerer. The information processing apparatus 1 provides the user U with the question generated in Step S3 via the Q&A service, for example.

The terminal apparatus 2 displays the question provided from the information processing apparatus 1 and generated in Step S3. For example, the terminal apparatus 2 displays the screen illustrated in (a) of FIG. 1 to display the question generated in Step S3.

In a case where the user U operates an answer button on the screen illustrated in (a) of FIG. 1, the terminal apparatus 2 displays a screen for inputting an answer, and the user U inputs an answer to the question generated in Step S3 as illustrated in (b) of FIG. 1. Thereafter, the user U can post the answer to the question generated in Step S3 by selecting a posting button illustrated in (b) of FIG. 1.

Subsequently, the information processing apparatus 1 receives posting of the answer to the question generated in Step S3 (Step S5). For example, the information processing apparatus 1 receives, as posting of the answer to the question generated in Step S3, information transmitted from the terminal apparatus 2 of the candidate for the answerer, the information being information answered by the candidate for the answerer to the question generated in Step S3.

Furthermore, the information processing apparatus 1 can also receive, as posting of the answer to the question generated in Step S3, information transmitted from the terminal apparatus 2 of a person other than the candidate for the answerer, the information being information answered by the person other than the candidate for the answerer to the question generated in Step S3.

In the Q&A service, the information processing apparatus 1 provides the user U with information including the question generated in Step S3 and the answer received in Step S5 (Step S6). For example, the information processing apparatus 1 provides the user U with information including the question including the search word specified by the user U and generated in Step S3 and the answer received in Step S5 to the question.

Furthermore, the information processing apparatus 1 can also provide the user U with information including the question generated in Step S3 on a web page for each category in the Q&A service and the answer received in Step S5 to the question.

Furthermore, the information processing apparatus 1 receives a search query for information in a web search service (Step S7). For example, the information processing apparatus 1 receives a search query transmitted from the terminal apparatus 2 in response to operation of the terminal apparatus 2 by the user U.

The information processing apparatus 1 performs search processing corresponding to the search query received in Step S7 based on the answer received in Step S5 (Step S8). For example, in a case where the search query received in Step S7 is the same as the search query used to generate the question in Step S3, the information processing apparatus 1 performs search processing based on the answer received in Step S5.

For example, by using a ranking model in which a weight of a feature amount corresponding to a keyword included in the answer received in Step S5 is increased, the information processing apparatus 1 performs the search processing so as to increase a display rank of the web content related to the answer received in Step S5 in the search result. The ranking model is a neural network-based model, but may be a model using logistic regression, a decision tree, or the like.

For example, in a case where the number of posts such as information of the character string “Cafe XXX is recommended” is large with respect to the question generated from a search query #1, and the search query received in Step S6 is the search query #1, the information processing apparatus 1 performs the search processing so as to increase a display rank of the web content related to “Cafe XXX” in the search result. The search query #1 includes, for example, information of a character string “Please let us know a recommended cafe in Nishi-ku, FUKUOKA”, but is not limited to such an example.

For example, by using the ranking model in which a weight of a feature amount corresponding to “Cafe XXX” is increased, the information processing apparatus 1 can perform the search processing so as to increase the display rank of the web content related to “Cafe XXX” in the search result.

The information processing apparatus 1 transmits a search result indicating a result of the search processing performed in Step S8 to the terminal apparatus 2 that has transmitted the search query (Step S9). As a result, the information processing apparatus 1 can provide the user U with the result of the search processing corresponding to the search query received in Step S7 based on the answer received in Step S5.

In this manner, the information processing apparatus 1 generates a question based on the search query used for searching for the web content, receives an answer by the user U to the question, and provides information including the generated question and the received answer. This enables the information processing apparatus 1 to improve convenience of the user U.

Hereinafter, a configuration, and the like, of the information processing system 100 including the information processing apparatus 1, the plurality of terminal apparatuses 2, and the like, that perform such processing will be described in detail.

### [2. Configuration of Information Processing System 100]

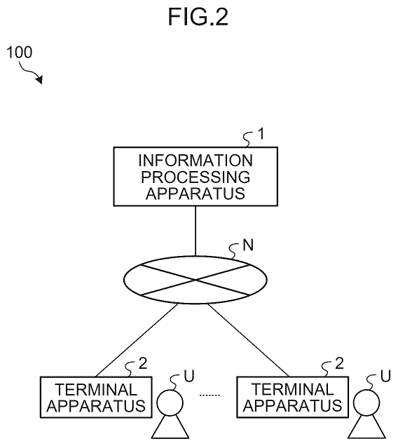

FIG. 2 is a view illustrating an example of a configuration of the information processing system 100 according to the embodiment. As illustrated in FIG. 2, the information processing system 100 according to the embodiment includes the information processing apparatus 1 and the plurality of terminal apparatuses 2.

The plurality of terminal apparatuses 2 are used by different users U. Each of the terminal apparatuses 2 is, for example, a notebook personal computer (PC), a desktop PC, a smartphone, a tablet PC, or a wearable device. The wearable device is, for example, a smart glass, a smart watch, or the like, but is not limited to such an example.

The information processing apparatus 1 and each of the terminal apparatuses 2 are communicably connected to each other in a wired or wireless manner via a network N. Note that the information processing system 100 illustrated in FIG. 2 may include a plurality of information processing apparatuses 1, and the like.

The network N includes, for example, a wide area network (WAN) such as the Internet and a mobile communication network such as long term evolution (LTE), fourth generation (4G), or fifth generation (5G).

Each of the terminal apparatuses 2 is connected to the network N via short-range wireless communication such as a mobile communication network, Bluetooth (registered trademark), or a wireless local area network (LAN), and can communicate with the information processing apparatus 1.

### [3. Configuration of Information Processing Apparatus 1]

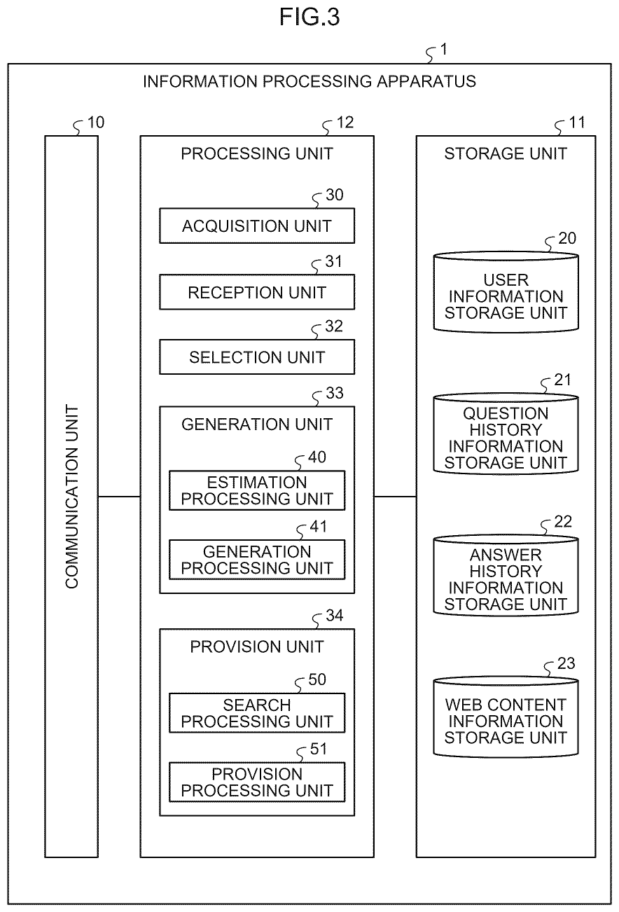

FIG. 3 is a view illustrating an example of a configuration of the information processing apparatus 1 according to the embodiment. As illustrated in FIG. 3, the information processing apparatus 1 includes a communication unit 10, a storage unit 11, and a processing unit 12.

### [3.1. Communication Unit 10]

The communication unit 10 is implemented by, for example, a communication module, a network interface card (NIC), or the like. Further, the communication unit 10 is connected to the network N in a wired or wireless manner, and transmits and receives information to and from various other apparatuses. For example, the communication unit 10 transmits and receives information to and from the terminal apparatus 2 via the network N.

### [3.2. Storage Unit 11]

The storage unit 11 is implemented by, for example, a semiconductor memory element such as a random access memory (RAM) or a flash memory, or a storage apparatus such as a hard disk or an optical disk. The storage unit 11 includes a user information storage unit 20, a question history information storage unit 21, an answer history information storage unit 22, and a web content information storage unit 23.

### [3.2.1. User Information Storage Unit 20]

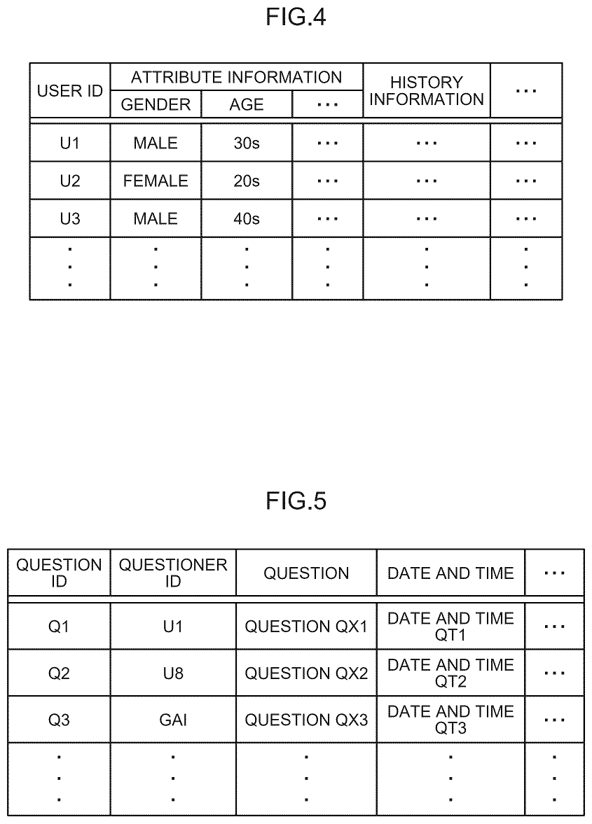

The user information storage unit 20 stores various types of information regarding the user U. FIG. 4 is a view illustrating an example of a user information table stored in the user information storage unit 20 of the information processing apparatus 1 according to the embodiment.

In the example illustrated in FIG. 4, the user information table stored in the user information storage unit 20 includes information of items such as “user identifier (ID)”, “attribute information”, and “history information”. The “user ID” is an identifier for identifying the user U, and is information attached to each user U.

The “attribute information” is attribute information indicating the attribute of the user U associated with the “user ID”. The attribute of the user U is, for example, a demographic attribute, a psychographic attribute, or the like. The demographic attribute is a demographic attribute, and includes, for example, a plurality of attribute items such as generation (age), gender, occupation, place of residence, annual income, and family structure.

The psychographic attribute is a psychological attribute, and includes, for example, a plurality of attribute items regarding a lifestyle, a sense of value, an interest, and the like. For example, each of the plurality of attribute items in the psychographic attribute is an object of interest of the user U such as travel, fashion, science, book, art, technology, music, sports, music, and movie.

The “history information” includes information of behavior history of the user U associated with the “user ID”. The behavior history of the user U includes, for example, search history information, browsing history information, transaction history information, and the like.

The search history information of the user U includes, for example, information of search history of the user U in the web search service. The browsing history information of the user U includes, for example, information of browsing history of content by the user U in an online service. The transaction history information includes information of transaction history of a product by the user U in the online service.

### [3.2.2. Question History Information Storage Unit 21]

The question history information storage unit 21 stores various types of information regarding the question. FIG. 5 is a view illustrating an example of a question history table stored in the question history information storage unit 21 of the information processing apparatus 1 according to the embodiment.

In the example illustrated in FIG. 5, the question history table stored in the question history information storage unit 21 includes information of items such as “question ID”, “questioner ID”, “question”, and “date and time”. The “question ID” is an identifier for identifying a question, and is information attached to each question.

The “questioner ID” is a user ID of the user U in a case where the user U has posted the question associated with the “question ID” as a questioner, and is an ID of the generative AI in a case where the generative AI generates the question associated with the “question ID”. The ID of the generative AI is “GAI” in the example illustrated in FIG. 5, but is not limited to such an example.

The “question” is the question associated with the “question ID” and is a question sentence indicated by a character string, but may include an image. The “date and time” is information of date and time when the question associated with the “question ID” was made.

### [3.2.3. Answer History Information Storage Unit 22]

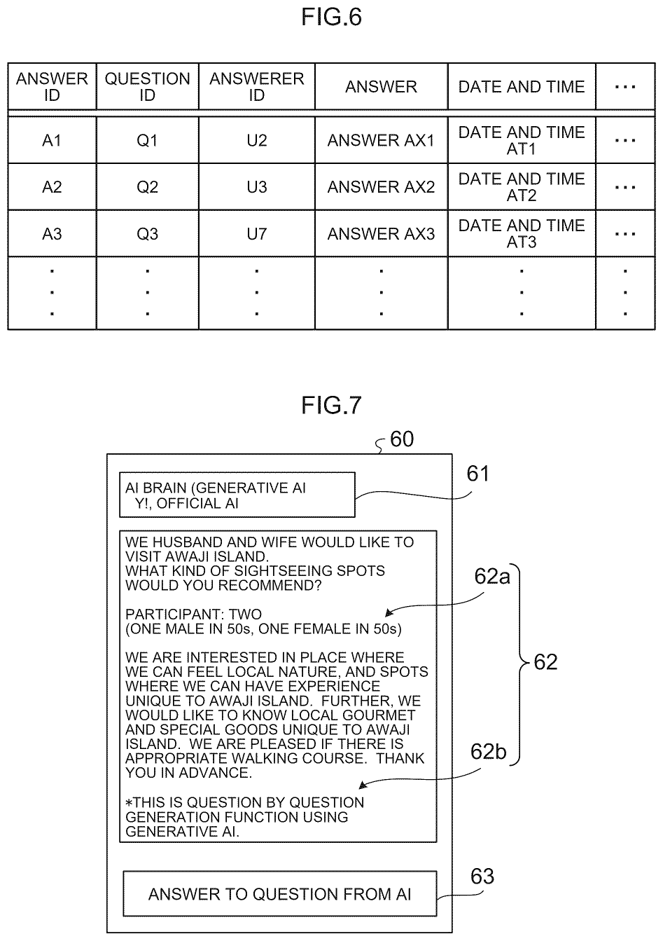

The answer history information storage unit 22 stores various types of information regarding the answer of the user U to the question. FIG. 6 is a view illustrating an example of an answer history table stored in the answer history information storage unit 22 of the information processing apparatus 1 according to the embodiment.

In the example illustrated in FIG. 6, the answer history table stored in the answer history information storage unit 22 includes information of items such as “answer ID”, “question ID”, “answerer ID”, “answer”, and “date and time”. The “answer ID” is an identifier for identifying an answer, and is information attached to each answer.

The “question ID” is a question ID of a question to which the answer associated with the “answer ID” is to be made. The “answerer ID” is the user ID of the user U who has posted the answer to the question associated with the “question ID”.

The “answer” is the answer associated with the “answer ID” and is an answer sentence indicated by a character string, but may include an image. The “date and time” is information of date and time when the answer associated with the “answer ID” was made.

### [3.2.4. Web Content Information Storage Unit 23]

The web content information storage unit 23 stores various types of information regarding each web content. The information regarding the web content stored in the web content information storage unit 23 is information to be used for search processing, and is, for example, a title, a uniform resource locator (URL), a body text, metadata, or the like, of the web content, but is not limited to such an example.

### [3.3. Processing Unit 12]

The processing unit 12 is a controller, and is implemented by, for example, a central processing unit (CPU), a micro processing unit (MPU), or the like, executing various programs stored in a storage apparatus inside the information processing apparatus 1 using a RAM as a work area.

Part or the whole of the processing unit 12 may be implemented by, for example, an integrated circuit such as an application specific integrated circuit (ASIC) or a field programmable gate array (FPGA).

As illustrated in FIG. 3, the processing unit 12 includes an acquisition unit 30, a reception unit 31, a selection unit 32, a generation unit 33, and a provision unit 34, and implements or executes functions and operation of information processing described below. Note that an internal configuration of the processing unit 12 is not limited to the configuration illustrated in FIG. 3, and may be another configuration as long as information processing to be described later is performed.

### [3.3.1. Acquisition Unit 30]

The acquisition unit 30 acquires various types of information from an external information processing apparatus, the terminal apparatus 2, or the like, via the communication unit 10, and causes the storage unit 11 to store the acquired information.

For example, the acquisition unit 30 acquires user information that is information of the user U from an external information processing apparatus, the terminal apparatus 2, or the like, via the communication unit 10, and adds the acquired user information to the user information table of the user information storage unit 20.

In addition, the acquisition unit 30 acquires various types of information from the storage unit 11. For example, the acquisition unit 30 acquires user information that is information of the user U from the user information storage unit 20, or the like. In addition, the acquisition unit 30 acquires information of question history from the question history information storage unit 21, or the like, and acquires information of answer history from the answer history information storage unit 22, or the like.

In addition, the acquisition unit 30 functions as a collection unit that collects information of the search query used for searching the web content. For example, the acquisition unit 30 collects information of the search query from the storage unit 11, the search server, or the like. For example, the search query is transmitted from the terminal apparatus 2 to the information processing apparatus 1, the search server, or the like, by the user U of the terminal apparatus 2 operating the terminal apparatus 2.

The information of the search queries includes the search queries, information of the user U who has transmitted the search queries, information indicating date and time of the search queries, and the like. The search queries include words, phrases, and the like, input by the user U. The information of the user U includes information indicating an attribute of the user U.

### [3.3.2. Reception Unit 31]

The reception unit 31 receives various requests, information, and the like, from the terminal apparatus 2 via the communication unit 10.

For example, the reception unit 31 receives posting of a question by the user U. For example, when question information transmitted from the terminal apparatus 2 is received, the reception unit 31 receives posting of the question by the user U based on the received question information.

Furthermore, the reception unit 31 receives posting of an answer to the question by the user U. For example, in a case where answer information transmitted from the terminal apparatus 2 is received, the reception unit 31 receives posting of the answer by another user U to the question based on the received answer information.

In addition, the reception unit 31 receives the answer by the user U to the question generated by the generation unit 33. For example, in a case where answer information transmitted from the terminal apparatus 2 is received, the reception unit 31 receives posting of the answer by the user U to the question generated by the generation unit 33 based on the received answer information.

For example, the reception unit 31 receives, as posting of the answer to the question generated by the generation unit 33, information that is the information answered by the candidate for the answerer to the question generated by the generation unit 33 and transmitted from the terminal apparatus 2 of the candidate for the answerer.

The candidate for the answerer is, for example, the user U for whom a frequency of answering the question is equal to or higher than a threshold, and is selected for each category, but is not limited to such an example. For example, the candidate for the answerer may be the user U for whom a rate selected as the best answer is equal to or higher than a threshold, or may be the user U for whom a frequency of answering a question is equal to or higher than a threshold and for whom a rate selected as the best answer is equal to or higher than a threshold.

Furthermore, the reception unit 31 can also receive, as posting of the answer to the question generated by the generation unit 33, information transmitted from the terminal apparatus 2 of a person other than the candidate for the answerer, the information being information answered by the person other than the candidate for the answerer to the question generated by the generation unit 33.

The reception unit 31 also receives a search query in the web content search service, which is transmitted from the terminal apparatus 2 of the user U. Such a search query is a search query for searching for the web content.

### [3.3.3. Selection Unit 32]

The selection unit 32 performs various kinds of selection. For example, the selection unit 32 selects information of one or more search queries from among the information of the plurality of search queries collected by the acquisition unit 30.

For example, the selection unit 32 classifies the information of the plurality of search queries collected by the acquisition unit 30 for each category. The categories in the Q&A service are classified by a combination of a large classification, a middle classification, and a small classification as described above, but are not limited to such an example.

For example, the selection unit 32 classifies the plurality of search queries for each category by rule-based classification or classification using a machine learning model. For example, the selection unit 32 has a keyword list in which a plurality of keywords is associated with each category, and can classify the search query into a category having the largest number of keywords included in the keyword list among words included in the search query.

In addition, the selection unit 32 can classify the plurality of search queries into categories using a classification model learned using the plurality of teacher data (pairs of search queries and categories). The classification model is generated, for example, by converting each search query of the teacher data into a feature amount and performing learning using the feature amount.

The feature amount is, for example, TF-IDF, Bow, or the like, but is not limited to such an example. The classification model is, for example, a regression model, support vector machine, a gradient boosting decision tree, a convolutional neural network, or the like, but is not limited to such an example.

The selection unit 32 extracts information of one or more search queries for each category based on the information of the plurality of search queries classified for each category as described above. For example, the selection unit 32 extracts one or more search queries satisfying a predetermined first condition for each category.

The first condition is, for example, a condition that the search query includes one or more trend words up to the top m-th rank (m is an integer of 1 or more), or a condition that the search query of the user U for whom a frequency of posting questions in the Q&A service is equal to or higher than a threshold, but is not limited to such an example.

The trend word is a word for which a proportion included in the search query is increasing. For example, the trend word is a word for which a rate of increase in the number of appearances per unit time is equal to or greater than a threshold and the latest number of appearances is equal to or greater than a threshold among words included in a plurality of search queries in a period up to a time before a predetermined period.

As described above, the selection unit 32 selects information of a search query that satisfies a predetermined second condition among the one or more search queries for each extracted category. The second condition is a condition that a combination of a plurality of terms that is not included in a question posted in a period up to a time before a predetermined period is included, or a condition that a combination of a plurality of terms that is included in a question posted in a period up to a time before a predetermined period but has a low posting frequency is included, but is not limited to such an example.

At least one of the first condition and the second condition may be a condition different for each category. For example, in a case where the large classification of the search query is the item “region, travel, outgoing”, the second condition may be a condition that information indicating a place is included, a condition that information indicating a place and information indicating a purpose at the place are included, or a condition that a combination of the plurality of terms described above is a combination of information indicating a place and information indicating a purpose at the place.

Note that the selection unit 32 can also select information of search queries randomly selected from among the one or more search queries for each category extracted as described above. Furthermore, the selection unit 32 can also randomly select information of the one or more search queries for each category based on the information of the plurality of search queries classified for each category.

### [3.3.4. Generation Unit 33]

The generation unit 33 generates various types of information. The generation unit 33 generates a question based on a search query used for searching for the web content in the web search service. For example, the generation unit 33 generates the question using the generative AI based on the search query.

For example, the generation unit 33 generates the question based on the information of the one or more search queries for each category selected by the selection unit 32. For example, the generation unit 33 generates a question including a plurality of terms included in the search query selected by the selection unit 32 for each category.

In addition, the generation unit 33 generates the question based on the search query selected by the selection unit 32 and the attribute of the user U of the terminal apparatus 2 that has transmitted the search query. The information indicating the attribute of the user U to be used by the generation unit 33 is information acquired by the acquisition unit 30 or information estimated by the generation unit 33.

Furthermore, the generation unit 33 can generate the question to which the answer of the candidate for the answerer can be received, based on behavior history of the candidate for the answerer. The candidate for the answerer is, for example, the user U for whom a frequency of answering the question per unit time is equal to or higher than a threshold, but is not limited to such an example. For example, the candidate for the answerer is the user U for whom an average value of evaluation by the questioner for the answer is equal to or greater than a threshold, or the user U for whom a frequency of answering the question per unit time is equal to or higher than the threshold and for whom an average value of evaluation by the questioner for the answer is equal to or greater than the threshold.

The generation unit 33 includes an estimation processing unit 40 that performs various kinds of estimation and a generation processing unit 41 that generates a question based on the search query. For example, the estimation processing unit 40 estimates the attribute of the user U of the terminal apparatus 2 that has transmitted the search query selected by the selection unit 32.

### [3.3.4.1. Estimation Processing Unit 40]

In a case where the information of the search query selected by the selection unit 32 does not include the information indicating the attributes of the family members including the user U of the terminal apparatus 2 that has transmitted the search query, the estimation processing unit 40 estimates the attributes of the family members including the user U of the terminal apparatus 2 that has transmitted the search query selected by the selection unit 32.

For example, the estimation processing unit 40 has a keyword list that is a list of keywords for each attribute (gender, generation (age), family structure, etc.), and estimates the attribute of the keyword list having the highest proportion of words included in the plurality of search queries of the user U as the attribute of the user U.

The estimation processing unit 40 can also estimate the attribute of the user U using an attribute estimation model. The attribute estimation model is generated by machine learning using a data set of a plurality of words included in a plurality of search queries transmitted from the terminal apparatus 2 by the same user U and the attribute of the user U. The attribute estimation model is, for example, a regression model, GBDT, a neural network, or the like, but is not limited to such an example.

The attribute estimation model is, for example, a model in which the number of appearances of words included in the search query is set as a feature amount, and the estimation processing unit 40 inputs the number of appearances of a plurality of words included in a plurality of search queries transmitted from the terminal apparatus 2 of the user U to be estimated to the attribute estimation model, and estimates the attribute having the highest score for each attribute output from the attribute estimation model as the attribute of the user U.

Note that the estimation processing unit 40 can also estimate the attribute of the user U using the generative AI, for example. For example, the estimation processing unit 40 causes the generative AI to estimate the attribute of the user U by inputting, to the generative AI, a plurality of search queries transmitted from the terminal apparatus 2 of the user U to be estimated and instruction information including information indicating an instruction to estimate the attribute of the user U from the plurality of search queries.

Furthermore, in a case where the information indicating the purpose is not included in the search query selected by the selection unit 32, the estimation processing unit 40 estimates the purpose at the place for which the information is included in the search query selected by the selection unit 32.

For example, the estimation processing unit 40 instructs the generative AI to estimate the purpose at the place for which the information is included in the search query selected by the selection unit 32. For example, the estimation processing unit 40 can input, to the generative AI, the instruction information including the information of the character string “Estimate the purpose at the place indicated by the given search query” and the information including the information in the search query as the input information, and cause the generative AI to output the information indicating the purpose at the place for which the information is included in the search query.

The information of the search query included in the input information to be input to the generative AI is the search query, but may include one or more pieces of information among information indicating the attribute of the user U of the terminal apparatus 2 that has transmitted the search query, information indicating the place of the terminal apparatus 2 that has transmitted the search query, and information indicating the transmission time of the search query.

Furthermore, the estimation processing unit 40 has, for example, a purpose list in which purposes for each place are listed, and can also estimate a purpose at the place for which information is included in the search query from the purpose list. The purpose list may be information in which purposes for each combination of the place and the attribute of the user U are listed, or may be information in which purposes for each combination of the place, the attribute of the user U, and search hours are listed.

### [3.3.4.2. Generation Processing Unit 41]

The generation processing unit 41 generates a question based on the search query. For example, the generation processing unit 41 generates the question based on the search query selected by the selection unit 32.

The question generated by the generation processing unit 41 is generated by, for example, a generation method selected by the operator of the information processing apparatus 1 among a rule-based generation method and a generation method using the generative AI.

The rule-based generation of the question is performed, for example, by extracting a plurality of types of terms according to the category from the search query using a category term list including a list of a plurality of types of terms for each category, and applying the extracted plurality of types of terms to a sentence of a template for each category.

For example, in a case where the category of the search query is the item of the large classification “region, travel, outgoing”, the category term list includes a list of terms indicating places and a list of terms indicating purposes. The generation processing unit 41 extracts a term indicating a place and a term indicating a purpose at the place from the search query using the category term list. The search query for extracting the term indicating the place and the search query indicating the term indicating the purpose may be the same or different from each other.

Then, the generation processing unit 41 generates a question by applying the term indicating the place and the term indicating the purpose at the place extracted from the search query to specific portions in the sentence of the template of the category including the category item “region, travel, outgoing”.

For example, the template is information of a character string “We would like to {term indicating the purpose} at {term indicating the region}. If you have any recommendation, please let us know”, or the like, but is not limited to such an example. The term indicating the place extracted from the search query is applied to the {term indicating the region}, and the term indicating the purpose extracted from the search query is applied to the {term indicating the purpose}.

{Term indicating the region} is, for example, a term indicating a name of a region such as Kyoto, Awaji island, and Kanazawa, and {term indicating the purpose} is, for example, a term indicating a purpose such as travel, sightseeing, eating and drinking, and staying, but is not limited to such an example.

In a case where the term indicating the place can be extracted from the search query but the term indicating the purpose at the place cannot be extracted from the search query, or the like, the generation processing unit 41 can generate a question based on a rule using the term indicating the purpose estimated by the estimation processing unit 40. As a result, the generation processing unit 41 can also generate a question including the information indicating the place and the information indicating the purpose at the place.

Note that the template may be different according to the combination of the large classification and the middle classification, or may be different according to the combination of the large classification, the middle classification, and the small classification.

In addition, the information of the search query includes the search query and the information of the user U of the terminal apparatus 2 that has transmitted the search query. The generation processing unit 41 can generate a question using the information of the user U in addition to the search query.

The information of the user U includes, for example, information indicating the attribute of the user U. The attribute of the user U is a demographic attribute such as gender, generation (age), address, family structure, occupation, and annual income, but may be a psychographic attribute such as an interest of the user U, a lifestyle, and an idea or tendency of an idea, or may be a combination of the demographic attribute and the psychographic attribute.

For example, the generation processing unit 41 can generate a question using a template including information of a character string “We would like to {term indicating the purpose} at {term indicating the region}. If you have any recommendation, please let us know. \n \n Participant: {family structure}”. A family structure based on information indicating the attribute of the search query is applied to {family structure}. For example, the question is information of a character string “1 male in 40s, 1 female in 40s, 1 male junior high school student”.

In this manner, the generation processing unit 41 can generate the question based on the search query and the information indicating the attribute of the user U of the terminal apparatus 2 that has transmitted the search query. The information indicating the attribute of the user U is the attribute information of the user U stored in the storage unit 11 or the attribute of the user U estimated by the estimation processing unit 40.

The generation of the question using the generative AI is generation using the generative AI capable of generating a text, and inputs information including information of the search query selected by the selection unit 32 to the generative AI as input information, and causes the generative AI to output the question.

The generative AI is, for example, text generative AI. The text generative AI is, for example, a large-scale language model learned to estimate and output a next token from an input token string, and is, for example, a transformer-based model, an RNN-based model, or the like, but may be a mixed model thereof. Furthermore, the text generative AI may be a composite system combined with identification machine, or the like, for preventing unauthorized use.

The transformer-based model is, for example, GPT, PaLM2, LLAMA, or the like, but is not limited to such examples. The RNN-based model is, for example, RWKV, or the like, but is not limited to such an example.

In a case where the term indicating the place and the term indicating the purpose at the place can be extracted from the search query, the generation processing unit 41 can cause the generative AI to generate a question including the term indicating the place and the term indicating the purpose at the place using information including the term indicating the place and the term indicating the purpose at the place as the input information.

Furthermore, in a case where the term indicating the place can be extracted from the search query but the term indicating the purpose at the place cannot be extracted from the search query, or the like, the generation processing unit 41 can include the term indicating the purpose estimated by the estimation processing unit 40 in the input information as information that complements the search query. As a result, the generation processing unit 41 can also generate a question including the information indicating the place and the information indicating the purpose at the place.

Note that the generative AI is desirably learned so as not to include personal information, or the like, in the generation result. The generative AI is arranged in an external information processing apparatus, and the generation processing unit 41 uses the generative AI via an API, but the generative AI may be arranged in the information processing apparatus 1.

The generation processing unit 41 inputs information including the information of the search query and instruction information indicating an instruction to generate a question using the information of the search query to the generative AI, and can cause the generative AI to generate a question according to the information of the search query.

The instruction information is, for example, information of a character string “You have a high-level question skill. Please create a question that many people find useful based on the given keyword”, but is not limited to such an example.

Further, the instruction information may include a restriction condition. The restriction condition is, for example, an upper limit value of the number of characters, an expression format, limitation of the type of each item included in the output content, and the like, and is set for each category, for example. The expression format is, for example, an expression format in a desu/masu form, an expression format in a veneer form, or the like. The items included in the output content are, for example, “participant”, “period”, and the like, in a case of a question regarding sightseeing, and are “participant”, “use application”, “drinking schedule”, “budget”, and the like, in a case of a question regarding gourmet, but are not limited to such an example. The “participant” includes, for example, age, gender, and the number of people.

The generative AI may be multi-modal generative AI, or the like. The multi-modal generative AI is, for example, generative AI capable of generating a text or an image from a text, an image, or the like. The multi-modal generative AI is, for example, GPT-4 Turbo with vision, gemini, CM3Leon, or the like, but is not limited to such an example.

Furthermore, in a case where the category is related to sightseeing or gourmet, the generation processing unit 41 can set information indicating an instruction to include information indicating the attributes of all family members including the user U who has transmitted the search query as “participant” in the instruction information as information indicating a restriction condition. Furthermore, in the instruction information, information indicating an instruction to include “participant” in the question as a virtual persona to increase reality may be included in the information indicating the restriction condition.

In this manner, the generation processing unit 41 can generate the question based on the search query and the attribute of the user U of the terminal apparatus 2 that has transmitted the search query. The information indicating the attribute of the user U to be used by the generation processing unit 41 is information indicating the attribute of the user U acquired by the acquisition unit 30 or information indicating the attribute of the user U estimated by the estimation processing unit 40.

Furthermore, the instruction information may include information indicating information of the search query and an example of a question corresponding to the information of the search query. For example, the instruction information is information of a character string “#example \n\n #Search query example \n Yokosuka sightseeing \n #Question example \n Please let us know sightseeing spots in Yokosuka that can be enjoyed by family. \n\n Participant: family of three (1 male in 30's, 1 female in 30's, 1 female in 10's) \n Season: summer vacation (July to August) \n\n In particular, we are interested in experience-based attractions that children can enjoy and educational sightseeing spots. We also want to know delicious local gourmet spots. Thanks in advance”.

Furthermore, the instruction information may include, for example, another question that satisfies a predetermined condition as an example question. Examples of the other questions that satisfy the predetermined condition include, but are not limited to, other questions for which the number of answers is equal to or larger than a threshold, other questions for which a period from when a question is made until the predetermined number of answers are made is within a threshold, other questions for which the number of answers is in top m, and other questions for which a period from when a question is made until the predetermined number of answers are made is short in top n.

In addition, the generation processing unit 41 generates a question to which an answer of the candidate for the answerer can be received, based on behavior history of the user U who is the candidate for the answerer. The candidate for the answerer is, for example, the user U for whom a frequency of answering the question is equal to or higher than a threshold.

The behavior history of the user U who is the candidate for the answerer is, for example, history of behavior including a keyword included in the search query, for example, history of behavior including a place indicated by the keyword included in the search query and a purpose at the place, and the behavior history of the user U can also read as history of experience of the user U.

The generation processing unit 41 generates a question to which the candidate for the answerer can easily answer based on the behavior history of the user U who is the candidate for the answerer. The behavior history of the user U includes history of an answer made in the past by the candidate for the answerer, and the generation processing unit 41 generates a question that the candidate for the answerer can easily answer based on, for example, a question corresponding to the answer made by the candidate for the answerer in the past.

For example, the generation processing unit 41 sets information further including information of a character string “The answerer who answers the question should create a question in consideration of ease of answer to the given question example” as instruction information, and inputs information including the instruction information and a question corresponding to the answer made by the candidate for the answerer in the past to the generative AI as input information.

### [3.3.5. Provision Unit 34]

The provision unit 34 provides various types of information. For example, the provision unit 34 transmits information including the question generated by the generation unit 33 to the terminal apparatus 2 of the candidate for the answerer, thereby providing the candidate for the answerer with information including the question generated by the generation unit 33. The provision unit 34 provides the user U with the question generated by the generation unit 33 via the Q&A service, for example.

Furthermore, the provision unit 34 provides information including the question generated by the generation unit 33 and the answer received by the reception unit 31. For example, the provision unit 34 provides an answer to the question generated by the generation unit 33 via the Q&A service which is a service for receiving an answer to the question.

For example, the provision unit 34 provides the user U with information including the question including the search word specified by the user U and generated by the generation unit 33, and the answer to the question received by the reception unit 31 through posting.

Furthermore, the provision unit 34 can also provide the user U with information including the question generated by the generation unit 33 on the web page for each category in the Q&A service and the answer to the question received by the reception unit 31 through posting.

Furthermore, the provision unit 34 has a search function of performing search processing according to the search query received by the reception unit 31. The search processing is web content search processing, and for example, search processing according to the search query is performed based on web content information stored in the web content information storage unit 23. The provision unit 34 includes a search processing unit 50 and a provision processing unit 51.

### [3.3.5.1. Search Processing Unit 50]

The search processing unit 50 performs search processing according to the search query in the search service received by the reception unit 31 based on the answer received by the reception unit 31 through posting.

For example, in a case where the search query received by the reception unit 31 is the same as the search query used for generating the question by the generation unit 33, the search processing unit 50 performs the search processing of the web content based on the answer of the user U to the question generated by the generation unit 33 using the search query.

For example, by using a ranking model in which a weight of a feature amount corresponding to the keyword included in the answer received by the reception unit 31 is increased, the search processing is performed so as to increase a display rank of the web content related to the answer received by the reception unit 31 through posting in the search result. The ranking model is a neural network-based model, but may be a model using logistic regression, a decision tree, or the like.

For example, in a case where the number of posts such as information of the character string “Cafe XXX is recommended” is large with respect to the question generated from the search query #1, and the search query received by the reception unit 31 is the search query #1, the search processing unit 50 performs the search processing so as to increase a display rank of the web content related to “Cafe XXX” in the search result. The search query #1 includes, for example, information of a character string “Please let us know a recommended cafe in Nishi-ku, FUKUOKA”, but is not limited to such an example.

For example, by using the ranking model in which a weight of a feature amount corresponding to “Cafe XXX” is increased, the search processing unit 50 can perform the search processing so as to increase the display rank of the web content related to “Cafe XXX” in the search result.

### [3.3.5.2. Provision Processing Unit 51]

The provision processing unit 51 provides the candidate for the answerer with information including the question generated by the generation unit 33 by transmitting the information including the question generated by the generation unit 33 to the terminal apparatus 2 of the candidate for the answerer. The provision processing unit 51 provides the user U with the question generated by the generation unit 33 via the Q&A service, for example. For example, the provision processing unit 51 provides information indicating that the question is generated using the generative AI together with the question.

Furthermore, the provision processing unit 51 provides information including the question generated by the generation unit 33 and the answer received by the reception unit 31. For example, the provision processing unit 51 provides the answer to the question generated by the generation unit 33 via the Q&A service which is a service for receiving an answer to the question.

For example, the provision processing unit 51 provides the user U with information including the question including the search word specified by the user U and generated by the generation unit 33, and the answer to the question received by the reception unit 31 through posting.

Furthermore, the provision processing unit 51 can also provide the user U with information including the question generated by the generation unit 33 on the web page for each category in the Q&A service and the answer to the question received by the reception unit 31 through posting.

Furthermore, the provision processing unit 51 provides a search result by the search processing unit 50. For example, the provision processing unit 51 transmits information indicating a list of the web content as the search result by the search processing unit 50 to the terminal apparatus 2 that has transmitted the search query for the web content, thereby providing the search result by the search processing unit 50 to the user U of the terminal apparatus 2 that has transmitted the search query for the web content.

FIG. 7 is a view illustrating an example of the question generation information provided by the provision processing unit 51 of the provision unit 34 in the processing unit 12 of the information processing apparatus 1 according to the embodiment, transmitted to the terminal, and displayed on the terminal apparatus 2. As illustrated in FIG. 7, a question generation information 60 displayed on the terminal apparatus 2 includes questioner information 61, question related information 62, and an answer button 63.

The questioner information 61 includes information indicating that the questioner is the generative AI. The question related information 62 includes question information 62a that is information indicating a question and attention information 62b that is information indicating that the question is generated by the generative AI. As a result, the provision unit 34 can provide information indicating that the question is generated using the generative AI together with the question. The answer button 63 is a button to be selected in a case where the user U of the terminal apparatus 2 gives an answer.

In a case where the answer button 63 is selected by the user U of the terminal apparatus 2, answer selection information that is information indicating that the answer button 63 is selected is transmitted from the terminal apparatus 2 to the information processing apparatus 1. The provision unit 34 transmits answer input information corresponding to the answer selection information to the terminal apparatus 2. The terminal apparatus 2 displays the answer input information provided from the provision unit 34.

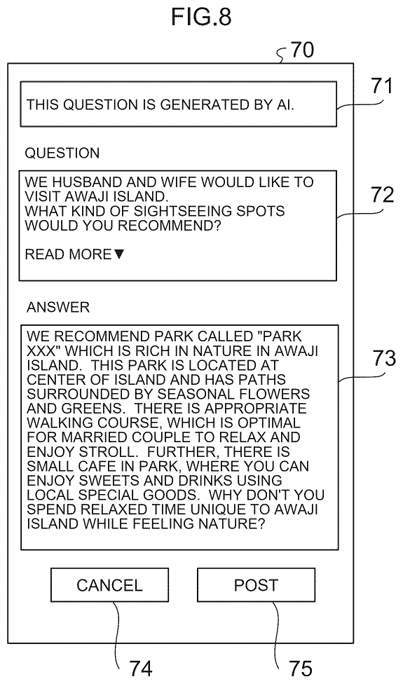

FIG. 8 is a view illustrating an example of the answer input information provided by the provision processing unit 51 of the provision unit 34 in the processing unit 12 of the information processing apparatus 1 according to the embodiment, transmitted to the terminal, and displayed on the terminal apparatus 2. As illustrated in FIG. 8, an answer input information 70 displayed on the terminal apparatus 2 includes attention information 71, question information 72, an answer input frame 73, a cancel button 74, and a posting button 75.

The attention information 71 is information indicating that the question is generated by the generative AI. The question information 72 is information indicating a question. The answer input frame 73 is an input frame to which an answer is to be input by the user U, and the user U can input an answer to the answer input frame 73 by operating the terminal apparatus 2.

The cancel button 74 is a button to be selected by the user U to cancel the answer. The posting button 75 is a button for posting the answer input in the answer input frame 73. The user U can post the answer input in the answer input frame 73 to the Q&A service by operating the terminal apparatus 2 and selecting the posting button 75.

### [4. Processing Procedure]

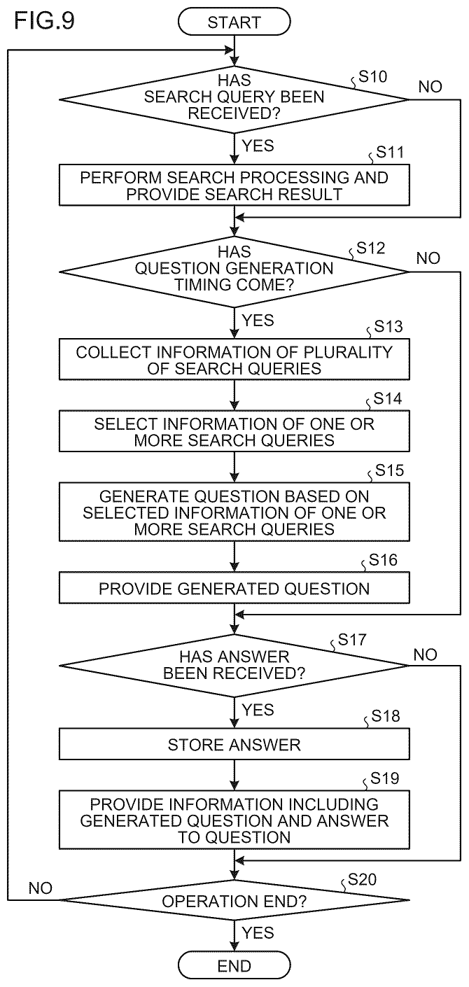

Next, procedure of information processing by the processing unit 12 of the information processing apparatus 1 according to the embodiment will be described. FIG. 9 is a flowchart indicating an example of information processing by the processing unit 12 of the information processing apparatus 1 according to the embodiment.

As indicated in FIG. 9, the processing unit 12 of the information processing apparatus 1 determines whether or not a search query has been received (Step S10). In a case where it is determined that a search query has been received (Step S10: Yes), the processing unit 12 performs search processing according to the received search query and provides a search result (Step S11).

In a case where the processing in Step S11 ends or in a case where it is determined that a search query has not been received (Step S10: No), the processing unit 12 determines whether or not a question generation timing has come (Step S12). The question generation timing is, for example, a timing that comes every predetermined period or a timing designated by the operator of the information processing apparatus 1, but is not limited to such an example.

In a case where it is determined that the question generation timing has come (Step S12: Yes), the processing unit 12 collects information of a plurality of search queries from an external search server or the storage unit 11 (Step S13). Then, the processing unit 12 selects information of one or more search queries based on a predetermined condition, or the like, among the information of the plurality of search queries collected in Step S13 (Step S14) and generates a question based on the information of the one or more selected search queries (Step S15). Then, the processing unit 12 provides the question generated in Step S15 (Step S16).

In a case where the processing of Step S16 ends, or in a case where it is determined that the question generation timing has not come (Step S12: No), the processing unit 12 determines whether or not the answer to the question provided in Step S18 has been received (Step S17). In a case where it is determined that the answer to the question provided in Step S18 has been received (Step S17: Yes), the processing unit 12 stores the received answer in the storage unit 11 (Step S18). Furthermore, the processing unit 12 provides information including the question generated in Step S15 and the answer to the question received in Step S17 (Step S19).

In a case where the processing of Step S19 ends, or in a case where it is determined that the answer to the question provided in Step S18 has not been received (Step S17: No), the processing unit 12 determines whether or not an operation end timing has come (Step S20). For example, in a case where the information processing apparatus 1 is powered off, the processing unit 12 determines that the operation end timing has come.

In a case where it is determined that the operation end timing has not come (Step S20: No), the processing unit 12 shifts the processing to Step S10, and in a case where it is determined that the operation end timing has come (Step S20: Yes), the processing indicated in FIG. 9 ends.

### [5. Modifications]

In a case where a term indicating a place can be extracted from the search query but a term indicating a purpose at the place cannot be extracted from the search query, or the like, the generation processing unit 41 can also generate a question based on a rule using a term indicating a purpose that is a trend at another place.

Furthermore, the generation processing unit 41 can include a plurality of questions for which no answer has been obtained in the instruction information as negative examples. Furthermore, the generation processing unit 41 can include a plurality of questions from which answers of a number equal to or larger than a threshold (for example, 10) have been obtained as positive examples in the instruction information.

The generation processing unit 41 can also summarize the past questions for each category and include the summarized questions in the instruction information as exclusion items in a new question. Furthermore, in a case where an answer has not been obtained for a certain period of time, the generation processing unit 41 can also regenerate a question with a different persona.

### [6. Hardware Configuration]

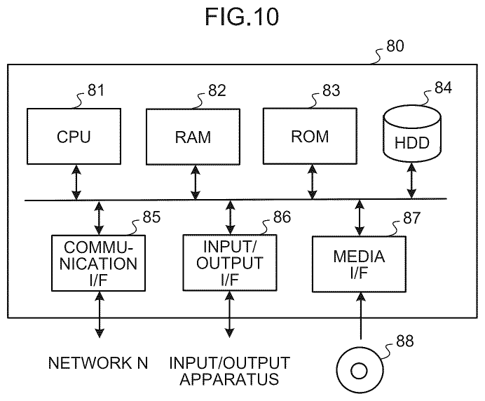

The information processing apparatus 1 according to the above-described embodiment is implemented by a computer 80 having a configuration as illustrated in FIG. 10, for example. FIG. 10 is a hardware configuration diagram illustrating an example of the computer 80 that implements functions of the information processing apparatus 1 according to the embodiment. The computer 80 includes a CPU 81, a RAM 82, a read only memory (ROM) 83, a hard disk drive (HDD) 84, a communication interface (I/F) 85, an input/output interface (I/F) 86, and a media interface (I/F) 87.

The CPU 81 operates based on a program stored in the ROM 83 or the HDD 84, and controls each unit. The ROM 83 stores a boot program to be executed by the CPU 81 when the computer 80 is started, a program depending on hardware of the computer 80, and the like.

The HDD 84 stores a program to be executed by the CPU 81, data to be used by the program, and the like. The communication interface 85 receives data from other devices via the network N (see FIG. 2), transmits the data to the CPU 81, and transmits data generated by the CPU 81 to other devices via the network N.

The CPU 81 controls an output apparatus such as a display and a printer, and an input apparatus such as a keyboard and a mouse via the input/output interface 86. The CPU 81 acquires data from the input apparatus via the input/output interface 86. In addition, the CPU 81 outputs the generated data to the output apparatus via the input/output interface 86.

The media interface 87 reads a program or data stored in a recording medium 88 and provides the program or data to the CPU 81 via the RAM 82. The CPU 81 loads the program from the recording medium 88 on the RAM 82 via the media interface 87, and executes the loaded program. The recording medium 88 is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 80 functions as the information processing apparatus 1 according to the embodiment, the CPU 81 of the computer 80 implements the function of the processing unit 12 by executing the program loaded on the RAM 82. In addition, the HDD 84 stores data in the storage unit 11. The CPU 81 of the computer 80 reads and executes these programs from the recording medium 88, but as another example, may acquire these programs from another apparatus via the network N.

### [7. Others]

Among the respective kinds of processing described in the above embodiment, all or part of the processing described as being automatically performed can be manually performed, or all or part of the processing described as being manually performed can be automatically performed by a known method. In addition, the processing procedure, specific name, and information including various kinds of data and parameters indicated in the document and the drawings can be arbitrarily changed unless otherwise specified. For example, various kinds of information indicated in each drawing are not limited to the indicated information.

In addition, the respective components of the respective apparatuses illustrated in the drawings are functionally conceptual, and are not necessarily physically configured as illustrated in the drawings. In other words, a specific form of distribution and integration of the respective apparatuses is not limited to the illustrated form, and all or part thereof can be functionally or physically distributed and integrated in an arbitrary unit according to various kinds of load, usage conditions, and the like.

For example, the above-described information processing apparatus 1 may be implemented by a terminal apparatus and a server computer, may be implemented by a plurality of server computers, or may be implemented by calling an external platform, or the like, with an API, network computing, or the like, depending on functions, so that the configuration can be flexibly changed.

In addition, the above-described embodiment and modifications can be appropriately combined within a range that does not contradict processing content.

### [8. Effects]

As described above, the information processing apparatus 1 according to the embodiment includes the generation unit 33 that generates a question based on a search query used for searching for web content, the reception unit 31 that receives an answer by the user U to the question generated by the generation unit 33, and the provision unit 34 that provides information including the question generated by the generation unit 33 and the answer received by the reception unit 31. This enables the information processing apparatus 1 to improve convenience of the user U.

In addition, the generation unit 33 generates the question based on the search query and an attribute of the user U of the terminal apparatus 2 that has transmitted the search query. This enables the information processing apparatus 1 to further improve convenience of the user U.

In addition, the generation unit 33 includes the estimation processing unit 40 that estimates the attribute of the user U of the terminal apparatus 2, and the generation processing unit 41 that generates a question based on the search query and the attribute estimated by the estimation processing unit 40. This enables the information processing apparatus 1 to improve convenience of the user U. This enables the information processing apparatus 1 to further improve convenience of the user U.

Furthermore, the search query includes information indicating a place and information indicating a purpose at the place, and the generation unit 33 generates, as the question, a question including the information indicating the place and the information indicating the purpose at the place. This enables the information processing apparatus 1 to further improve convenience of the user U.

Furthermore, the search query includes information indicating a place, and the generation unit 33 includes the estimation processing unit 40 that estimates a purpose at the place, and the generation processing unit 41 that generates a question including the information indicating the place and information indicating the purpose estimated by the estimation processing unit 40. This enables the information processing apparatus 1 to further improve convenience of the user U.

In addition, the generation unit 33 generates a question to which an answer of a candidate for an answerer can be received, based on behavior history of the candidate for the answerer. This enables the information processing apparatus 1 to further improve convenience of the user U.

Furthermore, the provision unit 34 provides an answer to the question generated by the generation unit 33 via a service for receiving an answer to the question. This enables the information processing apparatus 1 to further improve convenience of the user U.

Furthermore, the reception unit 31 receives a search query in a search service of web content, and the provision unit 34 includes the search processing unit 50 that performs search processing according to the search query in the search service received by the reception unit 31 based on the answer received by the reception unit 31, and the provision processing unit 51 that provides a search result by the search processing unit 50. This enables the information processing apparatus 1 to further improve convenience of the user U.

Furthermore, the search processing unit 50 performs the search processing based on the answer received by the reception unit 31 in a case where the search query received by the reception unit 31 is the same as the search query used for the generative AI of the question. This enables the information processing apparatus 1 to further improve convenience of the user U.

In addition, the generation unit 33 generates a question by the generative AI. As a result, the information processing apparatus 1 can improve generation accuracy of the question.

Furthermore, the provision unit 34 provides information indicating that the question is generated using the generative AI together with the question. This enables the information processing apparatus 1 to further improve convenience of the user U.

Although the embodiment of the present application has been described in detail with reference to the drawings, this is merely an example, and the present invention can be implemented in other forms to which various modifications and improvements have been made based on the knowledge of those skilled in the art, including the aspects described in the disclosure of the invention.

In addition, the “unit (section, module, unit)” described above can be read as “means”, “circuit”, or the like. For example, the acquisition unit can read as acquisition means or an acquisition circuit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a generation unit that generates a question based on a search query used for searching for web content;
a reception unit that receives an answer by a user to the question generated by the generation unit; and
a provision unit that provides information including the question generated by the generation unit and the answer received by the reception unit.

2. The information processing apparatus according to claim 1, wherein
the generation unit generates the question based on the search query and an attribute of a user of a terminal apparatus that has transmitted the search query.

3. The information processing apparatus according to claim 2, wherein
the generation unit includes:
an estimation processing unit that estimates the attribute of the user of the terminal apparatus; and
a generation processing unit that generates the question based on the search query and the attribute estimated by the estimation processing unit.

4. The information processing apparatus according to claim 1, wherein
the search query includes information indicating a place and information indicating a purpose at the place, and
the generation unit generates, as the question, a question including the information indicating the place and the information indicating the purpose at the place.

5. The information processing apparatus according to claim 1, wherein
the search query includes information indicating a place, and
the generation unit includes:
an estimation processing unit that estimates a purpose at the place; and
a generation processing unit that generates a question including the information indicating the place and information indicating the purpose estimated by the estimation processing unit.

6. The information processing apparatus according to claim 1, wherein
the generation unit generates a question to which an answer of a candidate for an answerer can be received, based on behavior history of the candidate for the answerer.

7. The information processing apparatus according to claim 1, wherein
the provision unit provides an answer to the question generated by the generation unit via a service for receiving an answer to a question.

8. The information processing apparatus according to claim 1, wherein
the reception unit receives a search query in a search service of the web content, and
the provision unit includes:
a search processing unit that performs search processing according to the search query in the search service received by the reception unit based on the answer received by the reception unit; and
a provision processing unit that provides a search result by the search processing unit.

9. The information processing apparatus according to claim 8, wherein
the search processing unit performs the search processing based on the answer received by the reception unit in a case where the search query received by the reception unit is a same as the search query used to generate the question.

10. The information processing apparatus according to claim 1, wherein
the generation unit generates the question by generative AI.

11. The information processing apparatus according to claim 10, wherein
the provision unit provides information indicating that the question is generated using the generative AI together with the question.

12. An information processing method to be executed by a computer, the information processing method comprising:
generating a question based on a search query used for searching for web content;
receiving an answer by a user to the generated question; and
providing information including the generated question and the received answer received.

13. A non-transitory computer readable storage medium storing information processing program causing a computer to execute:
generating a question based on a search query used for searching for web content;
receiving an answer by a user to the generated question; and
providing information including the generated question and the received answer.
